(19) United States
(12) Patent Application Publication
(10) Pub. No.: US 2011/0253009 A1
(43) Pub. Date: Oct. 20, 2011

(54) PAINTBALL FILL MATERIAL

(75) Inventors: Christopher Black, Chateauguay (CA); Michael J. Ratko, Windsor (CA); Richmond Italia, Lachine (CA)

(73) Assignee: GI SPORTZ, INC., Lachine (CA)

(21) Appl. No.: 13/090,822

(22) Filed: Apr. 20, 2011

Related U.S. Application Data
(60) Provisional application No. 61/325,849, filed on Apr. 20, 2010.

(51) Int. Cl. C08L 89/00

(52) U.S. Cl. 106/160.1; 106/501.1; 106/124.1

(57) ABSTRACT

According to principles of this invention, flour can be used as a filler for either an oil-based or PEG-based paintball fill material. In one embodiment of the present invention, a paintball fill material preferably comprises flour. More particularly, a paintball according to principles of the present invention can comprise a gelatin capsule defining an interior chamber which, upon formation of the paintball, houses a fill material. The fill material can comprise, for instance, 1%-65% polyethylene glycol, 25%-45% flour, and up to 0.5% dye, with the balance water. Accordingly, unlike conventional paintballs, the paintball fill material of the present invention preferably contains flour rather than starch to reduce the amount of polyethylene glycol required for the fill material. In alternative formulations, an oil can be used in addition to, or instead of, polyethylene glycol. According to another aspect of the present invention, the gelatin capsule for the paintball can also utilize flour in its composition. As with the fill material, the use of flour rather than starch in the paintball shell composition can reduce equipment maintenance and production costs.

This Application is a non-provisional of and claims priority from U.S. Provisional Patent Application No. 61/325,849, filed Apr. 20, 2010, the contents of which are incorporated herein by reference in their entirety.

### BACKGROUND OF THE INVENTION

1. Field of the Invention

The present invention relates generally to paintballs and, more particularly, to a paintball having a novel fill and/or shell material.

2. Related Art

In the sport of paintball, members of two or more teams are each equipped with pneumatic guns that shoot paint-filled capsules called “paintballs.” Using the pneumatic guns, the teams shoot the paintballs at members of the opposing team(s). When a paintball strikes an opponent, the paintball shatters and releases the fill material or “paint” onto the player, thereby “marking” that player. A marked player is out of the game.

Conventional paintballs comprise a frangible outer capsule that forms an interior chamber. The interior chamber contains the fill material. The outer shell is designed to shatter upon impact to release the paint. A disadvantage of conventional paintballs is that the fill material may contain a relatively high level of polyethylene glycol (PEG), which can be relatively expensive.

Various fill materials and compositions exist in the art, including that disclosed in U.S. Pat. No. 5,393,054, in which starch is used to reduce the amount of polyethylene glycol needed to fill a paintball capsule.

### SUMMARY OF THE INVENTION

According to principles of this invention, the applicant has discovered that using starch in the fill material may not be ideal. For instance, when subjected to pressure, such as in the injection process, starch may exhibit undesirable rheological traits. More specifically, starch may exhibit non-newtonian characteristics and become more rigid, hardening into a solid or semi-solid, and thereby resisting the application of the injection force. Starch may thereby increase the wear and tear on the manufacturing equipment and reduce the life and increase the maintenance expenses for such equipment.

Upon further research and experimentation, Applicant has discovered that flour may provide a more suitable filler for use in either an oil-based or PEG-based paintball fill material. In simplified terms, flour is typically the result of grinding up a food item (e.g., potato, corn, wheat, etc), whereas starch is extracted from a food item. Because the process for obtaining flour is generally easier than that for obtaining starch, flour is typically less expensive.

In one embodiment of the present invention, therefore, a paintball fill material preferably comprises flour and thereby overcomes disadvantages of prior fill materials. According to one embodiment, a paintball according to the present invention can comprise a gelatin capsule defining an interior chamber which, upon formation of the paintball, houses a fill material. The fill material can, for instance, comprise approximately about 1%-65% polyethylene glycol, approximately about 25%-45% flour, and up to approximately about 0.5% dye, with the balance water. Accordingly, unlike conventional paintballs, the paintball fill material of the present invention contains flour rather than starch to reduce the amount of polyethylene glycol required for the fill material. In alternative formulations, an oil can be used in addition to, or instead of, polyethylene glycol.

Flour does not exhibit the same degree of non-newtonian (hardening) properties as does starch when subjected to a force or pressure and therefore will likely not subject the manufacturing equipment to as much stress as starch. Flour is also relatively inexpensive and can therefore reduce the cost of the paintballs by reducing the amount of polyethylene glycol needed for the fill material.

According to another aspect of the present invention, the gelatin capsule for the paintball can comprise approximately about 9%-17% sorbitol, approximately about 35%-45% gelatine, approximately about 10%-20% glycerine, up to approximately about 10% flour, up to approximately about 0.5% color, with the balance water. The gelatin capsule of the present invention can also utilize flour in its composition. As in the fill material, the use of flour rather than starch in the paintball shell composition can reduce equipment maintenance and production costs.

Various other aspects, embodiments, and configurations of this invention are also possible without departing from the principles disclosed herein. This invention is therefore not limited to any of the particular aspects, embodiments, or configurations described herein.

### BRIEF SUMMARY OF THE DRAWINGS

The foregoing and additional objects and advantages of the present invention will become more readily apparent through the following detailed description, made with reference to the accompanying drawings, in which:

FIG. 1 is a somewhat schematic cut-away perspective view of a paintball comprising a shell and fill according to various aspects and embodiments of the present invention.

### DETAILED DESCRIPTION

The principles of the present invention will be described more fully hereinafter with reference to particular embodiments thereof. It should be recognized, however, that the invention may be embodied in many different forms and need not include every feature of the described embodiments and may include additional features readily known to those of skill in the art. The invention should therefore not be construed as being limited to any one or more of the specific embodiments described herein, nor as requiring specific features or a specific combination of features of these embodiments.

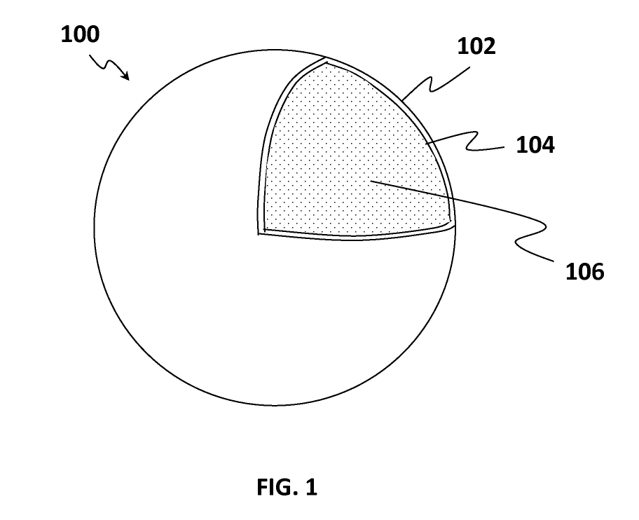

Referring to FIG. 1, a paintball 100 can comprise a substantially spherical gelatin capsule (or “shell”) 102 having an interior chamber 104. The interior chamber 104 is preferably filled with a fill material or “paint” 106. In use, the paintball can be launched by a pneumatic force (such as from a paintball gun) towards a target. Upon impact, the shell preferably shatters and releases the fill material against the target.

According to principles of the present invention, in either a PEG or oil-based system, an important factor in the formulation of the fill material is the combination of flour as a filler, a wetting agent (commonly an emulsifier), and a thickening agent to stabilize the suspension of the flour in the liquid. The flour is preferably prepared prior to introducing it into the PEG or oil-based fill material to facilitate its incorporation into the fill material.

According to one embodiment of the present invention, the fill material can comprise approximately 1%-65% polyethylene glycol, about 25%-45% flour, and up to about 0.5% dye, with the balance water. Of course, other ratios are also possible and fall within the spirit and scope of the present invention. Thus, unlike the prior art paintballs, the paintball fill material of the present invention contains a relatively high percentage of flour as well as a relatively low percentage of polyethylene glycol. By using flour rather than starch, the hardening properties of starch can be avoided and wear and tear on equipment can be reduced. Manufacturing and equipment maintenance and repair costs may also be reduced.

Polyethylene glycol (PEG) typically has a mean molecular weight of between 200 and 4000 and preferably comprises at least two polyethylene glycols, each of which has a different molecular weight. For instance, one polyethylene glycol preferably has a molecular weight of substantially 400 and can form the base liquid ingredient for the fill. PEG 400 can, for example, provide between about 45% and 65%, and more preferably around 50% to 55%, by weight of the fill material. Another polyethylene glycol has a mean molecular weight of greater than 3000, such as PEG 3350. PEG 3350 can be used as a thickening agent and can provide between about 1%-5%, and most preferably around 2%-3%, by weight of the fill material.

The fill material can also contain a third polyethylene glycol with a mean molecular weight of about 200. PEG 200 can provide about 1%-3% by weight of the fill material and can supply freeze-resistant properties to the fill material as well as protect the shell against embuttement by diffusion of the fill material. The polythylene glycol mixture can also contain about 1%-3%, and preferably around 1%-2%, glycerin by weight.

The flour preferably forms a suspension with the PEG base and can thereby form a reflective substrate for the dye. Although the fill can contain about 25%-45% by weight flour, it preferably it contains around 35%-42% by weight. Any of a plurality of different flours can be employed for the fill material. The flour, for instance, can be selected from the group of corn flour, potato flour, wheat flour, and/or other processed flour.

The following is but one example of a preferred embodiment of the fill material for the paint ball of the present invention.

### Example 1

| Material | Constituent Percent (by weight) |
|---|---|
| PEG 400 | 52% |
| PEG 3350 | 2% |
| PEG 200 | 1% |
| Flour | 42% |
| DYE | 0.02% |
| WATER | BALANCE |

Flour could also be used in the shell formulation. More specifically, flour can be used as a displacement material in the gelatin matrix, weakening the structure of the shell. A method of rendering the flour can be used before introducing it into the gelatin mix. The amount of flour can be adjusted to control the shell characteristics. With a weaker shell construction, a slightly thicker shell could be produced to make the ball rounder. The weaker, thicker shell would break upon impact similar to the thinner, high strength shell. A small amount of surfactant can help “wet” the flour in the shell formula.

The term “wetting” refers to the use of a liquid agent (such as an emulsifier or surfactant) to provide better adhesion between the liquid carrier and the solid particles. For example, an emulsifier can be used to “wet” the particles and provide better adhesion of the liquid carrier to the solid particles. The emulsifier can, for instance, be part of the molecular structure of the thickening agent—like emulsifying wax—or separate from the thickener. For example, a simple thickener like a wax could be used along with a separate emulsifier like lecithin or dish soap. A high speed mixer could also act as an emulsifier due to the high shear speed it is capable of providing. Any combination of a chemical emulsifier(s) and mechanical emulsification could be used to optimize the formulation. The shell can either be a sorbitol or non-sorbitol containing shell. For an oil-based paintball, neither sorbitol or mannitol need be included and the cost of the paintball can thereby be further reduced.

In one embodiment, the paintball shell formula can comprise around 9%-17% sorbitol, about 35%-45% gelatin, approximately 10%-20% glycerine, up to around 10% flour, and up to about 0.5% color, with the balance being water. Thus, unlike the previously known paintball gelatine capsules, the capsule of the present invention contains flour. The capsule can further include a sorbitan, a polyhydric acid, and up to about 3% mannitol.

The following is an example of a preferred composition for the gelatin capsule.

### Example 2

| Material | Constituent Percent (by weight) |
|---|---|
| GELATIN | 40% |
| GLYCERINE | 10.4% |
| SORBITOL | 10.4% |
| FLOUR | 4.8% |
| WATER | BALANCE |

In practice, the paintball manufactured according to the principles of the present invention can also provide the benefit of being less brittle than other paintballs. As such, breakage of the paintballs in the gun and during normal handling of the paintballs may be reduced.

Additionally, a paintball according to principles of the present invention may also be denser than other paintballs. This can enhance the ballistic properties of the paintball and improve its accuracy and range. Flour in the gelatin capsule can also provide a non-stick surface on the paint ball that reduces friction during loading and in the gun barrel during firing. The shell appearance may be matted rather than high gloss which can also improve its ballistic characteristics.

Having described and illustrated the principles of the invention in various embodiments thereof, it should be apparent that the invention can be modified in arrangement and detail without departing from such principles.

What is claimed is:

1. A paintball fill material comprising flour.

2. A paintball fill material according to claim 1, further comprising:
polyethylene glycol;
approximately between 25%-45% flour;
dye;
and water.

3. A paintball fill material according to claim 2, wherein the polyethylene glycol comprises approximately between 1-65% of the fill material by weight.

4. A paintball fill material according to claim 2, wherein the dye comprises no more than about 0.5% by weight of the fill material.

5. A paintball fill material according to claim 2, wherein the polyethylene glycol comprises a mixture of polyethylene glycol of different molecular weights.

6. A paintball fill material according to claim 5, wherein the polyethylene glycol mixture comprises polyethylene glycol having a molecular weight of around 400 and polyethylene glycol having a molecular weight of above approximately 3000.

7. A paintball fill material according to claim 6, wherein the polyethylene glycol mixture comprises approximately about 45% to 65% by weight of the polyethylene glycol having a molecular weight of around 400 and approximately about 1% to 5% by weight of the polyethylene glycol having a molecular weight of above approximately 3000.

8. A paintball fill material according to claim 5, wherein the polyethylene glycol mixture further comprises glycerin.

9. A paintball fill material according to claim 1, wherein the flour provides approximately between about 25% to about 45% of the fill material by weight.

10. A paintball fill material according to claim 1, wherein the fill material is an oil-based fill material.

11. A fill material for injecting into a paintball shell during formation of a paintball, said fill material comprising:
a filler comprising flour;
a liquid comprising a wetting agent; and
a thickening agent to stabilize the suspension of the flour in the liquid.

12. A fill material according to claim 11, wherein the wetting agent comprises an emulsifier.

13. A fill material according to claim 11, further comprising an ingredient providing freeze-resistant properties.

14. A fill material according to claim 11, further comprising an ingredient selected to protect the shell against embuttement by diffusion of the fill material.

15. A fill material according to claim 11, wherein the liquid comprising a wetting agent comprises a first polyethylene glycol and water; and wherein the thickening agent comprises a second polyethylene glycol having a different molecular weight than the first polyethylene glycol.

16. A paintball shell consisting of flour.

17. A paintball shell according to claim 16, wherein the shell consists of:
between approximately about 9%-17% sorbitol;
between approximately about 35%-45% gelatin;
between approximately about 10%-20% glycerine;
up to approximately about 10% flour;
up to approximately about 0.5% coloring;
and water.

18. A paintball shell according to claim 17, wherein the paintball shell further consists of:
a sorbitan;
a polyhydric acid; and
up to about 3% mannitol.

19. A paintball shell according to claim 16, wherein the paintball shell is formulated for an oil-based fill material, and wherein said shell contains neither sorbitol nor mannitol.

20. A paintball shell according to claim 16, wherein the flour is used as a displacement material in a gelatin mix of the shell to weaken the structure of the shell, wherein the flour is rendered before introducing it into the gelatin mix, and wherein the amount of flour helps determine the shell characteristics.
